(19) United States
(12) Patent Application Publication
(10) Pub. No.: US 2010/0135168 A1
(43) Pub. Date: Jun. 3, 2010

(54) METHOD FOR AUTOMATICALLY DETERMINING A GROUP OF PAIRS LOCATED CLOSE TO ANOTHER PAIR IN A COMMUNICATION NETWORK AND ASSOCIATED SERVER, ANALYSIS DEVICE AND COMMUNICATION DEVICE

(76) Inventors: Yi-Ping Chen, Rennes (FR); Ali Boudani, Rennes (FR); Gilles Straub, Acigne (FR)

Correspondence Address: Robert D. Shedd, Patent Operations;THOMSON Licensing LLC, P.O. Box 5312, Princeton, NJ, 08543-5312, US

(21) Appl. No.: 12/452,554

(22) PCT Filed: Jul. 4, 2008
(86) PCT No.: PCT/FR2008/051243

§ 371 Date: Jan. 8, 2010

(30) Foreign Application Priority Data
Jul. 10, 2007 (EP) 07301217.1
Mar. 17, 2008 (FR) 0851696

(51) Int. Cl. H04L 12/26

(52) U.S. Cl. 370/252

(57) ABSTRACT

A dedicated method for determining peers located close to another peer, each peer having at least one communication device connected to a communication node of a communication network including multiple communication nodes, of which some have a known fixed position and are known as “landmarks”. This method consists in, upon detection of a new peer, i) in determining in the communication network the closest landmark to the new peer, then ii) in determining from among the multiple nodes known as intermediary nodes that define the path linking this new peer to the pre-determined landmark, and iii) in determining a group of peers located close to the new peer as a function of at least the pre-determined path definition and the definitions of the paths linking other peers to at least the pre-determined landmark.

### TECHNICAL DOMAIN OF THE INVENTION

The invention relates to communication networks to which are connected items of communication equipment able to exchange content data, possibly multimedia data, in P2P (Peer-to-Peer) mode, and more specifically the P2P applications, notably in real time, that are implemented in such networks.

The invention relates to all communication networks (or infrastructures), wired or wireless, capable of transmitting content data (possibly multimedia) between items of user's communication equipment constituting peers. It can therefore be a wired network, such as a high or medium bitrate transmission line network, such as for example xDSL (x Digital Subscriber Line) type lines or cables or even optical fibres, or a wireless network (for example of mobile or cellular type) or of local type (standards WLAN (Wireless Local Area Network)—IEEE 802.11a, Wi-Fi (802.11g), ETSI HiperLAN/2), and WiMAX (IEEE 802.16, ETSI HiperMAN)).

Moreover, “communication equipment” is understood to mean any type of communication equipment being part of, or that can be connected to, a wired or wireless communications network. It can therefore be, for example, mobile (or cell) or fixed telephones, fixed computers or PDAs (Portable Digital Assistant) including “pocket PCs”, content receivers (such as for example decoders, residential gateways or STBs (Set-Top Boxes) as long as they are equipped with communication means to exchange content data.

In addition, “content” is understood here to mean a set of data that defines a television or video or audio programme (radio or musical) or games or multimedia, or again an electronic file (or data).

### PRIOR ART

As those skilled in the art know, some P2P applications, such as for example video stream broadcasting (which includes Video on Demand or VoD), for which the contents are pre-recorded and fully available, and live streaming, for which the contents are broadcast live as they are created) have heavy time constraints, generally of real time type, that require a recovery (or “download”) of content data according to a speed greater than the data consumption speed. In order to enable the download of content, the network supplies to the peers a list of peers that receive a same content, and a peer can establish connections in parallel with several peers from this list to increase its download bitrate.

To construct an exhaustive list for a vast communication network, such as for example the Internet, is an impossible and useless task given that a peer can never establish communications in parallel with all of the peers of this list. Therefore, the network generally only supplies a peer with a truncated (or partial) list of peers (typically of a few tens or hundreds) selected randomly.

Once a peer has a truncated list, it must determine the “good” peers that offer a connection quality sufficient for its requirements. To do this, it can for example use a “tit-for-tat” type algorithm that enables “bad” peers that do not offer a connection quality sufficient to its requirements, to be rejected. During the time (sometimes called convergence time) that is required by a peer to determine the good peers, the download bitrate is relatively low. This does not influence the Quality of Service (QoS) of a file sharing type P2P application, but this is unacceptable for an application with a strong temporal constraint, for example of VoD or live streaming type, as it introduces a relatively long “zapping time”.

Moreover, in the case of a random draw selection, some peers may be retained to form part of a truncated list although they are (very) far from the peer that requires content data, which is not optimal in terms of utilisation of (communication) network resources and may be costly for the operators when connections are made via several networks.

In order to improve the situation, some methods for determination of peers according to the inter-peers distance have been proposed. Among these methods that can particularly be cited is that entitled Meridian, that is notably described in the document by B. Wong et al., “Meridian: a lightweight network location service without virtual coordinates”, SIGCOMM, 2005. This method consists in measuring for each peer, its distance (or number of skips) with respect to other peers. Each peer thus maintains a small set of neighbours, classed according to their distance (from one another) and organised in the form of rings of different radii. This Meridian method presents a “local” approach for the estimation of distance, according to which the peers create their specific local coordinates according to Round-Trip Time (or RTT).

The method known as Vivaldi can also be cited, which is notably described in the document by F. Dabek et al., “Vivaldi: a decentralized network coordinate system”, SIGCOMM, 2004. This method consists in attributing virtual coordinates to each peer in order to predict the distances (or number of skips) that separate them. Each new peer measures its latency with respect to a few other peers, in order to determine its position in the virtual space. This position serves subsequently to estimate its distance with respect to peers occupying other positions.

These methods are all based on the Round-Trip Time (RTT) transmission times, but they do not take into account the network topology, is which limits their precision. Moreover, these methods are intended for decentralised applications for which the peers are not under the control of a central item of equipment, so they are not adapted to some applications, such as for example applications requiring audits or security measurements.

### SUMMARY OF THE INVENTION

The purpose of the invention is therefore to improve the situation.

For this purpose, the invention first proposes a method dedicated to the determination of peers located close to another peer (in the physical sense of the term rather than in the logical sense), each peer having at least one item of communication equipment connected to a communication node of a communication network comprising multiple communication nodes of which some have a known fixed position and are known as “landmarks”.

This method is characterized by the fact that it consists, in the case of detection of a new peer:
in determining within the network the landmark closest to the new peer, then
in determining from among the multiple intermediary nodes that define a path connecting the new peer to the determined landmark, and
in determining a group of peers located close to the new peer according to at least the definition of this path and definitions of paths that connect other peers (connected to the network) to at least the determined landmark.

“new peer” is understood here to be a peer that has just connected for the first time to the network by means of an item of equipment having a communication address, such as for example an IP address, or a peer that is already connected to the network under a communication address, such as for example an address, and that re-connects under another communication address, such as for example another IP address, possibly by means of another item of equipment (if it has more than one).

The method according to the invention can comprise other characteristics that can be taken individually or in combination, notably:
the landmark can be determined that is closest to the new peer i) by transmitting from this latter to each of the network landmarks a first interrogation message requiring a response, then ii) by determining each time elapsed between the instant of transmission of a first interrogation message and the instant of reception of a response transmitted by one of the landmarks, and iii) by retaining the landmark that corresponds to the shortest time lapse,
as a variant, the landmark can be determined that is closest to the new peer i) by transmitting from this latter to each of the network landmarks that are designated in a list a first interrogation message requiring a response, then ii) by determining each time elapsed between the instant of transmission of a first interrogation message and the instant of reception of a response transmitted by one of the landmarks designated in the list, and iii) by retaining the landmark that corresponds to the shortest time lapse,
   each first interrogation message can for example be of “ping” type,
the intermediary nodes can be determined that define a path i) by transmitting from the new peer to the determined landmark a second interrogation message requiring a response on its part and on the part of each intermediary node that precedes it, then ii) by retaining the identifier of each intermediary node having transmitted a response message to the new peer following the reception of the second interrogation message,
   each second interrogation message can for example be of “traceroute” type,
the group of peers can be determined that are located close to the new peer according to at least the peers that are associated with paths passing through at least one intermediary node through which also passes the path connecting the new peer to the determined landmark,
the group of peers can be determined that are located close to the new peer also according to at least one criterion, for example selected from among (at least) the number of intermediary nodes separating a peer from the new peer and the size of the bandwidth available between a peer and the new peer,
a list of peers can be constituted with the peers of the determined group, a list in which the peers are classed according to the number of skips required to join them,
each peer can signal its presence by transmitting a third message periodically.

The invention also proposes a server for a communication network to which are connected items of peers communication equipment and comprising multiple communication nodes some of which have a known fixed position and are known as “landmarks”.

This server is characterized by the fact that it is responsible, in the case of detection of a new peer, for determining a group of peers that are located close to this new peer according to at least the knowledge, on one part, of nodes of the multiple nodes, called intermediary nodes, that define a path connecting the new peer to the landmark that is closest to this last, and on the other hand, of intermediary nodes of the multiple nodes that define paths connecting other peers (connected to the network) to at least the landmark that is closest to the new peer.

The server according to the invention can comprise other characteristics that can be taken individually or in combination, notably:
it can be charged with determining the group of peers that are located close to the new peer according to at least the peers that are associated with paths passing through at least one intermediary node through which also passes the path connecting the new peer to the landmark that is closest to the new peer,
it can be charged with determining the group of peers that are located close to the new peer also according to at least one criterion, for example selected from among (at least) the number of intermediary nodes separating a peer from the new peer and the size of the bandwidth available between a peer and the new peer,
it can be charged with constituting a list of peers with the peers of the determined group, this list being constituted of peers classed according to the number of skips required to join them,
it can be charged with determining the group of peers among the peers that have signal their presence to it by means of a third message,
it can be charged with reconstituting an entire (synthetic) topology, representative of the communication network, by aggregation of received paths.

The invention also proposes an analysis device for an item of communication equipment of a peer connected to a communication node of a communication network including multiple communication nodes of which some have a known fixed position and are known as “landmarks”.

This analysis device is characterized by the fact that it is charged with determining within the network the landmark closest to its peer communication equipment, then determining from among the multiple nodes the nodes known as intermediary nodes that define a path connecting this peer communication equipment to the determined landmark.

The device according to the invention can comprise other characteristics that can be taken separately or in combination, notably:
it can be charged with determining the landmark (that is closest to its peer communication equipment) i) by generating a first interrogation message requiring a response intended for each of the landmarks of the network, then ii) by determining each time elapsed between the instant of transmission of a first interrogation message and the instant of reception of a response message transmitted by one of the landmarks, and iii) by retaining the landmark that corresponds to the shortest time lapse,
as a variant, it can be charged with determining the landmark (that is closest to its peer communication equipment) i) by generating a first interrogation message requiring a response intended for each of the landmarks of the network that are designated in a list, then ii) by determining each time elapsed between the instant of transmission of a first interrogation message and the instant of reception of a response message transmitted by one of the landmarks designated in the list, and iii) by retaining the landmark that corresponds to the shortest time lapse,
   each first interrogation message can for example be of “ping” type,
it can be charged with determining the intermediary nodes that define a path i) by generating a second interrogation message requiring a response on its part and on the part of each intermediary node that precedes it intended for the landmark (that is closest to its peer communication equipment), then ii) by retaining the identifier of each intermediary node having transmitted a response message to its peer communication equipment following the reception of the second interrogation message,
   each second interrogation message can for example be of “traceroute” type.

The invention also proposes an item of communication equipment, intended for connection to a communication network, and equipped with an analysis device of the type presented above.

### BRIEF DESCRIPTION OF THE DRAWINGS

Other characteristics and advantages of the invention will appear upon examination of the detailed description hereafter, and the annexed drawings, wherein:

FIG. 1 illustrates very diagrammatically and functionally peers communication equipment, equipped with an analysis device according to the invention, and a server according to the invention connected to a communication network,

FIG. 2 illustrates schematically an example of determination by two new peers landmarks that are the closest to them, and

FIG. 3 illustrates schematically an example of determination by two new peers and paths that connect them to the landmark that is the closest to them.

The annexed drawings can be used not only to complete the invention, but also to contribute to its definition, if necessary.

### DETAILED DESCRIPTION

The purpose of the invention is to enable the determination of a group of peers located close to another peer in order to download content data, each peer having at least one item of communication equipment connected to a communication node of a communication network enabling communications in peer-to-peer (P2P) mode.

The notion of closeness (or proximity) must be understood here in the physical sense of the term and not in the logical sense.

Hereafter, it is considered as a non-restrictive example, that the (communication) network is a wired network (for example of the ADSL type) providing an IP access. But, the invention is not limited to this type of communication network. It relates in fact to all types of communication networks (or infrastructures) having at least an access network, wired or wireless, capable of transmitting contents data (possibly multimedia) between items of communication equipment constituting peers. Therefore, the access network can be a wired network, such as a cable or optical fibre network, or a wireless network, such as a mobile (or cellular) network or a local area network (WLAN and WiMAX standards).

It will be noted that the invention relates to both to situations in which a single communication network is implicated, as well as to situations in which several (even high numbers of) communication networks (possibly of different types) are interconnected, as is for example the case of the network of networks known as Internet. Moreover, the invention also relates to the situations in which a single communication network has several access networks, wired or wireless, of different types.

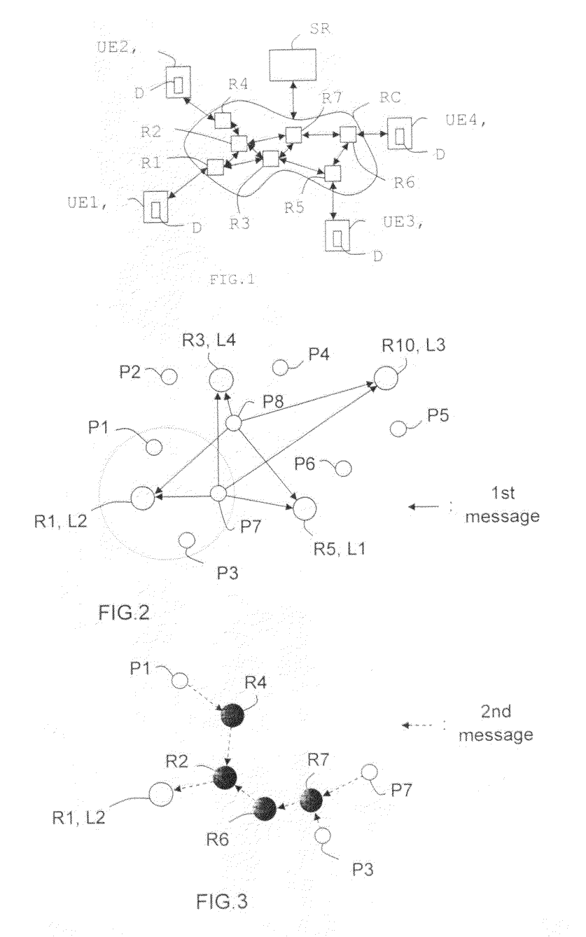

A (communication) network RC has been schematically illustrated on FIG. 1 comprising multiple communication nodes Rj to some of which are connected items of user communication equipment UEi that constitute peers Pi. Index j takes here values ranging between 1 and 7, but it can take any value equal to or greater than one. Moreover, index i takes here values ranging between 1 and 4, but it can take any value equal to or greater than two.

In a wired access network, the communication nodes Rj are generally routers, and those to which are attached the peers Pi are for example of DSLAM multiplexer type (case of a wired network of xDSL type). It is understood that in other types of access network, such as for example a wireless access network, the communication nodes Rj can be items of access network equipment other than routers. Thus, in a radio access network the communication nodes Rj to which are connected the peers Pi are generally base stations (BS, BTS or Node B) or access points (in the case of a WLAN network).

Taking into account the illustrative choice made above, it is considered in what follows, as a non-restrictive example, that the items of (communications) equipment UEi of peers Pi are fixed or portable computers.

But, the invention is not limited to this type of (communications) equipment. It relates in fact to all types of communications equipment capable of exchanging content data, by wired or wireless paths, with another item of communications equipment, via at least a (communications) network and in P2P mode. It can therefore also involve, for example, mobile (or cell) or fixed telephones, PDAs (Portable Digital Assistant) including “pocket PCs”, content receivers (such as for example decoders, residential gateways or STBs (Set-Top Boxes) as long as they are equipped with the communication means to exchange content data in P2P mode.

In what follows an item of equipment UEi is assimilated to the peer Pi that it constitutes within an RC (communications) network.

It will be noted that the contents could for example be broadcast to the items of equipment UEi in streaming mode and live within the framework of a video on demand (VoD) service or a programme broadcast service (for example television or radio or even music) or files (or data) possibly created live (or in live streaming).

The invention proposes a method enabling determination of a group of peers Pi′ located close to a new peer Pi (i≠i′) in order to enable this latter to download content data in peer-to-peer mode (or P2P).

“new peer” is understood here to be a peer Pi that has just connected for the first time to the network RC by means of an item of equipment UEi having a communication address, such as for example an IP address, or a peer that is already connected to the network RC under a communication address, such as for example an IP address, and that re-connects under another communication address, such as for example another IP address, possibly by means of another item of equipment UEi (if it has more than one). Using this definition, it is certain that a P2P client Pi that uses for example his portable computer UEi in different areas (such as for example his residence, his office, a hotel and an airport) will not be systematically considered as being located in a same and single location. Each peer generally transmits a (first) ping type message and a (second) traceroute type message each time it leaves a network or returns to a network, thus enabling determination of its geographical position.

The method according to the invention comprises two main steps.

A first main step comprises two sub-steps (i and ii). It is intended to determine (estimate) the topology of the part of the network RC to which the new peer Pi is attached. This first step is carried out each time a new peer Pi connects to the network RC. It requires that the network RC comprises among its multiple communication nodes Rj a certain number of nodes known as “landmarks” Lk having a known fixed position and thus a fixed and known communication address (for example IP).

These landmarks Lk are for example items of network equipment that have a more important role than the others within the network RC. It could for example involve what those skilled in the art refer to as super nodes that work with nodes located in their neighbouring area. They are preferably distributed throughout the network RC.

There are no constraints on the positions of landmarks Lk. But, it is preferable to place them in a central zone of the network RC so that they are at approximately the same distance from all the peers Pi to reduce the traffic of second messages (for example of traceroute type). Practically, it can involve routers that are implanted in the core network of the network RC. It suffices in fact that a communication node Rj is able to respond to the first messages (for example of ping type) in order to be able to become a landmark Lk.

Moreover, the more landmarks Lk there are, the more the estimations can be precise. But, due to a question of cost, it is understood that the number of landmarks Lk results in practice from a compromise between the precision sought and the cost. Typically, approximately ten landmarks Lk constitutes a good compromise.

The first sub-step (i) of this first main step consists, in the case of detection of a new peer Pi, in determining within the network RC the landmark Lk that is closest to this new peer Pi.

This first sub-step (i) is preferably carried out by the new peer Pi. To do this, the equipment UEi that it uses to connect to the network RC must comprise (as illustrated), or be coupled to, an analysis device D according to the invention.

In order to determine the landmark Lk that is closest to an item of equipment UEi of a new peer Pi, at least two methods can be considered.

In a first method, the analysis device D of the new peer Pi begins by transmitting to each of the landmarks Lk of the network RC, a first interrogation message requiring a response.

Each first interrogation message generated can for example (although not restrictively) be of “ping” type.

It will be understood that each first interrogation message that is generated by an analysis device D is transmitted in the network RC by the item of equipment UEi with which it is associated. The analysis device D (or the associated item of equipment UEi) is supposed to know the communication address of each landmark Lk of the network RC.

As soon as a first interrogation message is transmitted to a landmark Lk, the analysis device D triggers a temporal counting that it interrupts when its equipment UEi receives from this landmark Lk a corresponding response message. The analysis device D can thus determine the time (RTT) that has elapsed between the instant of transmission of each first interrogation message and the instant of reception of each corresponding response message. Once the analysis device D has the time elapsed for the different landmarks Lk of the network RC, it only has to compare them with each other in order to determine that which is shortest and which corresponds to the landmark Lk closest to its equipment UEi.

It will be noted that it is advantageous that the analysis device D reiterates several times (at least twice) its generation of first interrogation messages intended for landmarks Lk and the corresponding calculations of time elapsed, due to fluctuations in transmission time that can occur in the network RC. In this case, the analysis device D determines for each landmark Lk the minimum elapsed time from among all those that it has obtained, then it compares among them the minimum elapsed time corresponding to the different landmarks Lk in order to retain the landmark that is associated with the shortest minimum elapsed time.

A network RC comprising only four landmarks L1 to L4 (k=1 to 4) and eight peers P1 to P8 (i=1 to 8) is schematically represented in the non-restrictive example of FIG. 2. The peers P1 to P6 are “old” peers already known to the network RC, while the peers P7 and P8 are new peers that have just connected. In this example, the item of equipment UE7 of the new peer P7, like the item of equipment UE8 of the new peer P8, addresses to the four landmarks L1 to L4 respectively four first interrogation messages (for example of ping type). Here, the device D associated with the new peer P7 retains as the closest landmark that which is referenced L2 (and which is the node R1), while the device D associated with the new peer P8 retains as the closest landmark that which is referenced L4 (and which is the node R3).

In a second method, the analysis device D of the new peer Pi begins by transmitting, to each of the landmarks Lk that are designated in a list that it has for example received from the network RC, a first interrogation message requiring a response.

Again, each first interrogation message generated can for example (though non-restrictively) be of “ping” type.

The communication address of each landmark Lk of the list is contained in this list.

As soon as a first interrogation message is transmitted to a landmark Lk of the list, the analysis device D triggers a temporal counting that it interrupts when its equipment UEi receives from this landmark Lk a corresponding response message. Once the analysis device D has the time elapsed for the different landmarks Lk of the list, it only has to compare them with each other in order to determine that which is shortest and which corresponds to the landmark Lk closest to its equipment UEi.

It will be noted that it is also advantageous that the analysis device D reiterates several times (at least twice) its generation of first interrogation messages intended for the landmarks Lk of the list and the calculations of the corresponding elapsed times. In this case, it determines for each landmark Lk of the list the minimum elapsed time from among all those that it has obtained, then it compares among them the minimum elapsed time corresponding to the different landmarks Lk of the list in order to retain the landmark that is associated with the shortest minimum elapsed time.

The second sub-step (ii) of the first main step consists in determining from among the multiple nodes Rj of the network RC those, known as intermediary nodes, that define the path Cik that connects the new peer Pi to the landmark Lk that has just been determined and that is the closest to this new peer Pi.

It will be understood that a path Cik is defined by the communication addresses of a new peer Pi and a landmark Lk, as well as generally at least one intermediary node Rj.

This second sub-step (ii) is also and preferentially carried out by the new peer Pi, and more specifically by the analysis device D of the item of equipment UEi that it uses to connect to the network RC.

In order to determine the path Cik, the analysis device D of the new peer Pi begins by generating, for the landmark Lk that has just been determined and that is closest to it, a second interrogation message requiring a response from it and from each intermediary node Rj that precedes it.

Each second interrogation message generated can for example (although not restrictively) be of “traceroute” type.

It will be understood that each second interrogation message that is generated by an analysis device D is transmitted in the network RC by the item is of equipment UEi with which it is associated to the determined landmark Lk.

As soon as the second interrogation message is received by an intermediary node Rj located on the path that it takes between the new peer Pi and the determined landmark Lk, this intermediary node Rj transmits to the new peer Pi a response message containing its specific communication address (or identifier).

The analysis device D associated with the new peer Pi is thus informed of the communication addresses (or identifiers) of intermediary nodes Rj that define the path Cik connecting its new peer Pi to the determined landmark Lk. It then has at its disposition, so to speak, the topology of the network relative to its new peer Pi.

Four intermediary nodes R2, R4, R6 and R7 located for example placed in the circle of FIG. 2 that contains the landmark L2 (R1) and the peers P1, P2, P3 and P7, have been schematically represented in the non-restrictive example of FIG. 3. Here, the peers P3 and P7 are connected to the intermediary node R7, while the peer P1 is connected to the intermediary node R4. In this example, the item of equipment UE7 of the new peer P7 addresses to the landmark L2 a second interrogation message (for example of traceroute type). The device D, associated with the new peer P7, receives response messages to its second from intermediary nodes R7, R6 and R2, if indeed it deduces that the path C72 that connects the new peer P7 to the landmark L2 passes through these three intermediary nodes R7, R6 and R2.

The second main step (iii) of the method according to the invention begins after the determination of the path Cik that connects a new peer Pi to the (closest) landmark Lk. It consists in determining a group of peers Pi′ (i′≠i) that are located close to (physically and not logically) the new peer Pi according to at least the definition of its path Cik (that has just been determined) and definitions (already known) of the paths Ci′k that connect other peers Pi′ (connected to the network RC) to at least the landmark Lk determined during the first main step.

In other words, the group of peers Pi′ neighbouring a new peer Pi is determined according to (at least) the topology of the network relative to this new peer Pi (defined by its path Cik) and the network topologies relative to at least the peers Pi′ (defined by their respective paths Ci'k) that have as their closest landmark the same one as that which is Lk of the new peer Pi.

Preferably, this determination is made more specifically according to at least peers Pi′ that are associated with paths Ci'k passing through at least one intermediary node Rj through which also passes the path Cik that connects the new peer Pi to the determined (closest) landmark Lk. In the non-restrictive example of FIG. 3, the peers P3 and P1 satisfy this constraint of intermediary node(s) Rj in common with the new peer P7, as the path C32 of the peer P3 passes through the same intermediary nodes R7, R6 and R2 as the path C72 of the new peer P7 and the path C12 of the peer P1 passes through the same intermediary node R2 as the path C72 of the new peer P7. The peers P1 and P3 therefore constitute potential candidates for the group of peers that must be determined for the new peer P7.

This type of determination is notably facilitated when each path definition Cik delivered by a device D is ordered. By “ordered definition” is understood the ordered list of communication addresses (or identifiers) of a new peer Pi, then from the first intermediary node Rj to which it is connected, then from every possible other intermediary node Rj′ located between this first intermediary node Rj and the determined landmark Lk, and finally the landmark Lk.

It is important to note that to determine the group of peers Pi′ located in the neighbourhood of a new peer Pi at least one criterion can also be used.

Among these criteria, there is one that is particularly useful when there is a desire to limit the traffic within a network RC. It relates to the number of intermediary nodes Rj that separate a peer Pi′ from a new peer Pi. It will be understood in fact that the more the number of intermediary nodes Rj that separate a peer Pi′ from a new peer Pi is reduced, the less resources are used in the network RC. As a result, it is advantageous to limit as much as possible the number of skips required at the transmission of content data between two peers Pi′ and Pi. It will be noted that the number of skips constitutes a distance criterion, a peer Pi′ being then considered as “good” for a new peer Pi if it is close to the latter.

Thus only the peers Pi′ need be selected that can be joined by a new peer Pi by means of a number of skips (or distance) that is less than a selected threshold. As a variant, all of the peers Pi′ can initially be classed according to increasing number of skips (or distance) and only the N first peers Pi′ are selected (for example N=200). In these examples, a list of peers can be constituted comprising for each peer Pi′ of the determined group its peer identifier and communication address (for example its IP address), as well as preferably the number of skips required to connect it. Within such a list, the peers Pi′ can for example be classed according to increasing number of skips.

But other selection criteria can be used, such as for example (and non-restrictively) the bandwidth that is available between a peer Pi′ and a new peer Pi. In fact, the criterion or criteria used depend on the parameters of the network that is to be optimised, and thus the connection quality type that is to be obtained. Among these other criteria that can usually be cited are the quality and/or quantity of content data, the temporary availability of a peer Pi′ (and thus the contents that it stores), and the behaviour of a peer Pi′ with respect to other peers Pi″ (defined by a mark for example).

The second main step is preferentially carried out by a server SR that is connected to the network RC (as illustrated non-restrictively in FIG. 1) or that is part of the network RC, and that operates in a centralised way. Each path definition Cik associated with a new peer Pi is therefore transmitted to this server SR that stores it in the storage means, like for example a memory or a database. The server SR thus has at each instant information that defines the entire current topology of the network RC.

It will be understood that by means of all the path definitions Cik provided by the peers Pi, the server SR can reconstitute an entire “synthetic” topology by “aggregation” of paths Cik, that aim to represent the true communication network RC, and from which it can implement the selection of peers Pi′ that are located in the physical (and not logical) neighbourhood of the peers Pi.

It will be noted that so that the entire topology is truly representative of the current situation, it is preferable that each peer Pi connected to the network

RC signals its presence by transmitting to the server SR a third message periodically. This third message could be for example of “hello” type. The server SR can thus regularly update the information that define the entire typology of the network RC.

The server SR transmits to the new peer Pi, in a dedicated message, the list that designates the peers Pi′ of the group that it has determined for it. The new peer Pi can then use it in order to establish connections with the best peers Pi′ from this list (for example those that are associated with the lowest number of skips).

It will also be noted that the analysis device D according to the invention can be realized in the form of software modules. But, it can also be realised in part or entirely in the form of electronic circuits (hardware) or of a combination of software modules and electronic circuits.

The invention offers a number of advantages, among which are:
a reduced number of operations to carry out at the level of the centralised server, given that all the path determinations Cik are carried out by the new peers Pi,
the traffic provoked by the path determinations Cik is limited by the fact that these determinations are intended to determine the landmarks that are closest to the new peers,
the use of a centralised server offers more control possibilities (notably in the matter of audits, measurement, diagnostics, billing and similar operations).

The invention is not restricted to the embodiments of the analysis device, the communication equipment, the server and the neighbouring peers determination method described above, only as an example, but its covers all the variants that those skilled in the art will be able to envisage within the framework of the following claims.

1. Method for determining peers located close to another peer, each peer having at least one item of communication equipment connected to a communication node of a communication network comprising multiple communication nodes of which some have a known fixed position and are known as “landmarks”, consisting, in the case of detection of a new peer in determining within said network the landmark that is closest to said new peer, then ii) in determining from among said multiple nodes known as intermediary nodes that define a path connecting said new peer to said determined landmark, and iii) in determining a group of peers located close to said new peer according to at least the definition of said path and of path definitions connecting other peers, connected to said network, to at least said determined landmark.

2. Method according to claim 1, wherein said landmark is determined that is closest to said new peer i) by transmitting from this latter to each of said network landmarks a first interrogation message requiring a response, then ii) by determining each time elapsed between the instant of transmission of a first interrogation message and the instant of reception of a response transmitted by one of said landmarks, and iii) by retaining the landmark that corresponds to the shortest time lapse.

3. Method according to claim 1, wherein said landmark is determined that is closest to said new peer i) by transmitting from this latter to each of said network landmarks that are designated in a list a first interrogation message requiring a response, then ii) by determining each time elapsed between the instant of transmission of a first interrogation message and the instant of reception of a response transmitted by one of said landmarks designated in the list, and iii) by retaining the landmark that corresponds to the shortest time lapse.

4. Method according to claim 2, wherein each first interrogation message is of “ping” type.

5. Method according to claim 1, wherein the intermediary nodes are determined that define a path i) by transmitting from said new peer to the determined landmark a second interrogation message requiring a response on its part and on the part of each intermediary node that precedes it, then ii) by retaining the identifier of each intermediary node having transmitted a response message to the new peer following the reception of said second interrogation message.

6. Method according to claim 5, wherein each second interrogation message is of “traceroute” type.

7. Method according to claim 1, wherein the group of peers located close to said new peer are determined according to at least peers associated with paths passing through at least one intermediary node through which also passes said path connecting said new peer to said determined landmark.

8. Method according to claim 1, wherein the group of peers located close to said new peer are also determined according to at least one criterion.

9. Method according to claim 8, wherein each criterion is selected in a group comprising at least the number of intermediary nodes separating a peer from said new peer and the size of the bandwidth available between a peer and said new peer.

10. Method according to claim 1, wherein a list of peers is constituted with the peers of the determined group, a list in which said peers are classed according to the number of skips required to connect them.

11. Method according to claim 1, wherein each peer signals its presence by transmitting a third message periodically.

12. Server (SR) for a communication network to which are connected items of communication equipment of peers and comprising multiple communication nodes of which some have a known fixed position and are known as “landmarks”, wherein it is arranged, in the case of detection of a new peer, to determine a group of peers located close to said new peer according at least to the knowledge i) of nodes of said multiple nodes, known as intermediary nodes, that define a path connecting said new peer to the landmark that is closest to said new peer, and ii) intermediary nodes of said multiple nodes that define paths connecting other peers, connected to said network, to at least said landmark that is closest to said new peer.

13. Server according to claim 12, wherein it is adapted to determine the group of peers located close to said new peer according to at least the peers associated with paths passing through at least one intermediary node through which also passes said path connecting said new peer to said landmark which is closest to said new peer.

14. Server according to claim 12, wherein it is adapted to determine the group of peers located close to said new peer also according to at least one criterion.

15. Server according to claim 14, wherein each criterion is selected in a group comprising at least the number of intermediary nodes separating a peer from said new peer and the size of the bandwidth available between a peer and said new peer.

16. Server according to claim 12, wherein it is adapted to constitute a list of peers with the peers of the determined group, said list being constituted of peers classed according to the number of skips required to connect them.

17. Server according to claim 12, wherein it is adapted to determine the group of peers from among peers that have signalled their presence to it by means of a third message.

18. Server according to claim 12, wherein it is adapted to reconstitute an entire topology representative of said communication network by aggregation of received paths.

19. Analysis device for an item of communication equipment of a peer connected to a communication node of a communication network comprising multiple communication nodes some of which have a known fixed position and are known as “landmarks”, wherein it is adapted i) to determine within said network the landmark that is closest to its peer communication equipment, then ii) to determine among said multiple nodes the nodes known as intermediary nodes that define a path connecting said peer communication equipment to said determined landmark.

20. Device according to claim 19, wherein it is adapted to determine said landmark, that is closest to its peer communication equipment i) by transmitting to each of said network landmarks a first interrogation message requiring a response, then ii) by determining each time elapsed between the instant of transmission of a first interrogation message and the instant of reception of a response transmitted by one of said landmarks, and iii) by retaining the landmark that corresponds to the shortest time lapse.

21. Device according to claim 19, wherein it is adapted to determine said landmark, that is closest to its peer communication equipment i) by transmitting to the network landmarks that are designated in a list a first interrogation message requiring a response, then ii) by determining each time elapsed between the instant of transmission of a first interrogation message and the instant of reception of a response transmitted by one of said landmarks designated in the list, and iii) by retaining the landmark that corresponds to the shortest time lapse.

22. Device according to claim 20, wherein each first interrogation message is of “ping” type.

23. Device according to claim 19, wherein it is adapted to determine the intermediary nodes that define a path i) by transmitting to said landmark, that is closest to its peer communication equipment, a second interrogation message requiring a response on its part and on the part of each intermediary node that precedes it, then ii) by retaining the identifier of each intermediary node having transmitted a response message to its peer communication equipment following the reception of said second interrogation message.

24. Device according to claim 23, wherein each second interrogation message is of “traceroute” type.

25. Communication equipment, intended to be connected to a communication network, wherein it comprises an analysis device according to claim 19.
